(19) United States
(12) Patent Application Publication
(10) Pub. No.: US 2024/0403991 A1
(43) Pub. Date: Dec. 5, 2024

(54) ON-DEMAND VEHICLE MANAGEMENT DEVICE, ON-DEMAND VEHICLE MANAGEMENT SYSTEM, AND LOST ITEM DETECTION METHOD

(71) Applicant: Mitsubishi Electric Corporation, Tokyo (JP)

(72) Inventors: Takahisa AOYAGI, Tokyo (JP); Yusuke FUJIGAYA, Tokyo (JP); Sayuri FUKANO, Tokyo (JP); Kyosuke ISHII, Tokyo (JP)

(73) Assignee: Mitsubishi Electric Corporation, Tokyo (JP)

(21) Appl. No.: 18/694,816

(22) PCT Filed: Sep. 30, 2021
(86) PCT No.: PCT/JP2021/036220

§ 371 Date: Mar. 22, 2024

(51) Int. Cl. G06Q 50/47; G06V 20/56; G06V 20/59; G06V 20/64; G06V 40/10

(52) U.S. Cl. CPC G06Q 50/47; G06V 20/56; G06V 20/59; G06V 20/64; G06V 40/103; G06V 2201/07

(57) ABSTRACT

An on-demand vehicle management device includes a communication unit that receives detection data output by at least one of a sensor provided in or on an on-demand vehicle or a sensor installed along a travel route, a categorization information generation unit that recognizes a user, based on the detection data, and generates categorization information that associates an object represented by information included in the detection data with the user, as a possession of the user, a categorization information comparison unit that determines whether a change has occurred in a situation of the possession by making a comparison, on a per user basis, between the categorization information as of before the user gets on the on-demand vehicle and the categorization information as of when the user gets off the on-demand vehicle, and a warning notification unit that outputs warning information when it is determined that the change has occurred.

### FIELD

The present disclosure relates to an on-demand vehicle management device for managing an on-demand vehicle that is operated based on a user's use request, and to an on-demand vehicle management system, a lost item detection method, and an on-demand vehicle management program.

### BACKGROUND

A transport service is known that uses an on-demand vehicle operated based on a user's use request. In such transport service, it is difficult to make a visual check for presence of any item left behind each time a user gets on or off the vehicle. Patent Literature 1 describes that when a user terminates using the service, the vehicle asks the user whether the user has not left anything in the vehicle when the vehicle detects a person or an object in the vehicle.

### CITATION LIST

### Patent Literature

Patent Literature 1: Japanese Patent Application Laid-open No. 2020-77166

### SUMMARY OF INVENTION

### Problem to be Solved by the Invention

However, the technology described in Patent Literature 1 presents a problem in low accuracy of lost item detection. For example, when there is an object in the vehicle, the technology described in Patent Literature 1 detects the object as a lost item even when the object is not a possession of the user of concern. In addition, in a service offered in a manner such that multiple users simultaneously share a single vehicle, and get on and off at different places, the technology described in Patent Literature 1 detects a user remaining in the vehicle as a lost item when another user gets off the vehicle. Thus, correct detection of a lost item has been difficult.

The present disclosure has been made in view of the foregoing, and it is an object of the present disclosure to provide an on-demand vehicle management device capable of improving accuracy of lost item detection.

### Means to Solve the Problem

In order to solve the above-described problem and achieve the object, an on-demand vehicle management device according to the present disclosure includes: a communication unit to receive detection data output by at least one of a sensor provided in or on an on-demand vehicle operated based on a use request from a user or a sensor installed along a travel route of the on-demand vehicle; a categorization information generation unit to recognize a user who uses the on-demand vehicle, based on the detection data, and to generate categorization information that associates an object represented by information included in the detection data with the user, as a possession of the user; a categorization information comparison unit to determine whether a change has occurred in a situation of the possession of the user by making a comparison, on a per-user basis, between a plurality of sets of the categorization information including the categorization information as of before the user gets on the on-demand vehicle and the categorization information as of when the user gets off the on-demand vehicle; and a warning notification unit to output warning information when the categorization information comparison unit determines that a change has occurred in the situation of the possession of the user.

### Effects of the Invention

An on-demand vehicle management device according to the present disclosure is advantageous in capability of improving accuracy of lost item detection.

### BRIEF DESCRIPTION OF DRAWINGS

FIG. 1 is a diagram illustrating a configuration of an on-demand vehicle management system according to a first embodiment.

FIG. 2 is a diagram illustrating a functional configuration of the on-demand vehicle management device illustrated in FIG. 1.

FIG. 3 is a diagram illustrating a first example of detection data received by the communication unit illustrated in FIG. 2.

FIG. 4 is a diagram illustrating categorization information generated based on the detection data illustrated in FIG. 3.

FIG. 5 is a diagram illustrating the categorization information generated based on the detection data illustrated in FIG. 3.

FIG. 6 is a diagram illustrating a second example of detection data received by the communication unit illustrated in FIG. 2.

FIG. 7 is a diagram illustrating categorization information generated based on the detection data illustrated in FIG. 6.

FIG. 8 is a diagram illustrating an example of detection data obtained after the detection data illustrated in FIG. 6 is obtained.

FIG. 9 is a diagram illustrating categorization information generated based on the detection data illustrated in FIG. 8.

FIG. 10 is a diagram illustrating an example of change in the detection data received by the communication unit illustrated in FIG. 2.

FIG. 11 is a diagram illustrating categorization information generated from the detection data illustrated in FIG. 10.

FIG. 12 is a diagram illustrating a functional configuration of the on-demand vehicle illustrated in FIG. 1.

FIG. 13 is a diagram illustrating an example of warning information displayed by the display unit illustrated in FIG. 12.

FIG. 14 is a diagram illustrating an example of warning information output by the electroacoustic unit illustrated in FIG. 12.

FIG. 15 is a diagram illustrating a functional configuration of the roadside unit illustrated in FIG. 1.

FIG. 16 is a diagram illustrating a functional configuration of the user terminal illustrated in FIG. 1.

FIG. 17 is a diagram illustrating an example of warning information displayed by the user terminal illustrated in FIG. 16.

FIG. 18 is a flowchart for describing an operation of the on-demand vehicle management device illustrated in FIG. 1.

FIG. 19 is a flowchart for describing an operation of sending detection data performed by each of the on-demand vehicle and the roadside unit illustrated in FIG. 1.

FIG. 20 is a flowchart for describing an operation of outputting warning information performed by each of the on-demand vehicle, the roadside unit, and the user terminal illustrated in FIG. 1.

FIG. 21 is a diagram illustrating an example configuration of a computer system implementing the on-demand vehicle management device according to the first embodiment.

FIG. 22 is a diagram illustrating a dedicated hardware element for implementing functionality of the on-demand vehicle and of the roadside unit according to the first embodiment.

FIG. 23 is a diagram illustrating a configuration of a control circuit for implementing functionality of the on-demand vehicle and of the roadside unit according to the first embodiment.

### DESCRIPTION OF EMBODIMENT

An on-demand vehicle management device, an on-demand vehicle management system, a lost item detection method, and an on-demand vehicle management program according to an embodiment of the present disclosure will be described in detail below with reference to the drawings.

### First Embodiment

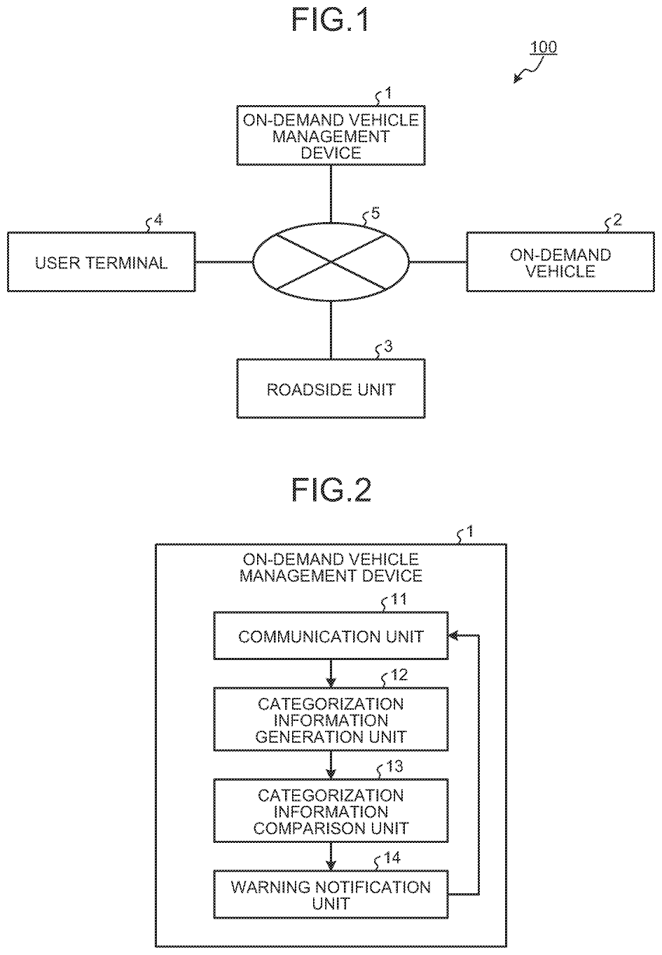

FIG. 1 is a diagram illustrating a configuration of an on-demand vehicle management system 100 according to a first embodiment. The on-demand vehicle management system 100 includes an on-demand vehicle management device 1, an on-demand vehicle 2, and a roadside unit 3. The on-demand vehicle management device 1, the on-demand vehicle 2, the roadside unit 3, and a user terminal 4 are connected to one another via a communication channel 5 such as the Internet.

The on-demand vehicle management device 1 is an information processing device for managing the on-demand vehicle 2, which is operated based on a user's use request. The on-demand vehicle management device 1 has functionality to detect an item left behind or a lost item (hereinafter referred to representatively as lost item) of a user who uses the on-demand vehicle 2, and to output warning information. The on-demand vehicle management device 1 may be, for example, an on-demand vehicle traffic control device that provides traffic control of the on-demand vehicle 2. The on-demand vehicle management device 1 can communicate with each of the on-demand vehicle 2, the roadside unit 3, and the user terminal 4.

The on-demand vehicle 2 is operated based on a user's use request, and transports the user from a boarding location to an alighting location. The boarding location and the alighting location may each be a location specified by the user, selected from multiple predetermined boarding-alighting spots, or a location in the service offering area, specified by the user. The following description assumes that the on-demand vehicle 2 allows the user to get on or off at a boarding-alighting spot. The on-demand vehicle 2 is capable of autonomous running. Although FIG. 1 illustrates a single on-demand vehicle 2, the on-demand vehicle management system 100 includes multiple on-demand vehicles 2.

The roadside unit 3 is installed along a travel route of the on-demand vehicle 2. Note that, as used herein, the phrase “travel route of the on-demand vehicle 2” refers to a road on which the on-demand vehicle 2 can travel in the offering area of a transport service using the on-demand vehicle 2. The roadside unit 3 can communicate with each of the on-demand vehicle management device 1 and the on-demand vehicle 2. The roadside unit 3 has functionality to assist autonomous running of the on-demand vehicle 2. For example, the roadside unit 3 has functionality to provide location information about the on-demand vehicle 2, location information about a vehicle present around the on-demand vehicle 2, and the like to the on-demand vehicle 2, and to provide information of a traffic light to the on-demand vehicle 2. Although FIG. 1 illustrates a single roadside unit 3, the on-demand vehicle management device 1 can be connected to multiple roadside units 3. Note that the following description assumes that the roadside unit 3 is installed at a boarding-alighting spot of the on-demand vehicle 2, but the roadside unit 3 may also be installed at a location other than a boarding-alighting spot in addition to the locations of the boarding-alighting spots.

The user terminal 4 is an information processing device owned by the user who utilizes a transport service using the on-demand vehicle 2. The user terminal 4 is a device portable by the user, examples of which include a smartphone and a tablet terminal. The user can reserve use of the on-demand vehicle 2 using the user terminal 4. The user terminal 4 includes a dedicated software application downloaded therein that has functionality such as reservation of use of a transport service using the on-demand vehicle 2. Alternatively or additionally, the user terminal 4 can access a website for reserving use of the on-demand vehicle 2 using an application such as a web browser.

The on-demand vehicle management system 100 includes a sensor (not illustrated) for detecting the user of the on-demand vehicle 2. The on-demand vehicle management system 100 has functionality to detect a lost item of the user based on detection data output by the sensor. The sensor is desirably provided at a location where the sensor can detect the user before getting on the on-demand vehicle 2 and the user at the time of getting off the on-demand vehicle 2. More desirably, a sensor is also provided at a location where the sensor can detect the user on board the on-demand vehicle 2. For example, the on-demand vehicle management system 100 is capable of detecting a lost item of the user based on detection data output by sensors provided in and on the on-demand vehicle 2 and by a sensor installed along the travel route of the on-demand vehicle 2. The sensors provided in and on the on-demand vehicle 2 include an in-vehicle sensor that outputs detection data obtained by sensing an interior of the on-demand vehicle 2, and a vehicle exterior sensor that outputs detection data obtained by sensing an exterior of the on-demand vehicle 2. The sensor installed along the travel route may be a sensor included in the roadside unit 3 installed along the travel route, or may be installed as a sensor by itself such as a surveillance camera.

The user transport service using the on-demand vehicle 2 may be, for example, a service that allows a user who has made a use reservation to charter the on-demand vehicle 2, or a service that utilizes a large-sized on-demand vehicle 2 and allows multiple users to share that single on-demand vehicle 2. The following description assumes that the user gets on and off the on-demand vehicle 2 at locations specified by the user selected from multiple predetermined boarding-alighting spots, and that the roadside unit 3 is installed at each of the boarding-alighting spots. It is also assumed that the on-demand vehicle management system 100 uses detection data output by an in-vehicle sensor provided inside the on-demand vehicle 2 and by a sensor provided in the roadside unit 3 to detect a lost item of the user of the on-demand vehicle 2.

FIG. 2 is a diagram illustrating a functional configuration of the on-demand vehicle management device 1 illustrated in FIG. 1. The on-demand vehicle management device 1 includes a communication unit 11, a categorization information generation unit 12, a categorization information comparison unit 13, and a warning notification unit 14.

The communication unit 11 communicates with other devices such as the on-demand vehicle 2, the roadside unit 3, and the user terminal 4 using communication means such as a 4th generation (4G) mobile communication system, a 5th generation (5G) mobile communication system, or a Wireless Fidelity (Wi-Fi) (registered trademark) communication system. Specifically, the communication unit 11 is capable of receiving detection data output by the in-vehicle sensor provided in the on-demand vehicle 2 and detection data output by the sensor provided in the roadside unit 3. It is assumed here that each of the on-demand vehicle 2 and the roadside unit 3 continually sends detection data at predetermined intervals. The communication unit 11 outputs the detection data received, to the categorization information generation unit 12. The communication unit 11 is further capable of sending warning information that has been output by the warning notification unit 14 when a lost item of the user has been detected, to the on-demand vehicle 2, to the roadside unit 3 located near the on-demand vehicle 2 at the time of detection, and to the user terminal 4 owned by the user who has been determined to have left the lost item.

The categorization information generation unit 12 recognizes the user who uses the on-demand vehicle 2, based on the detection data received by the communication unit 11, and generates categorization information that associates an object represented by information included in the detection data with the user of the on-demand vehicle 2, as a possession of that user. The categorization information generation unit 12 outputs the categorization information generated, to the categorization information comparison unit 13.

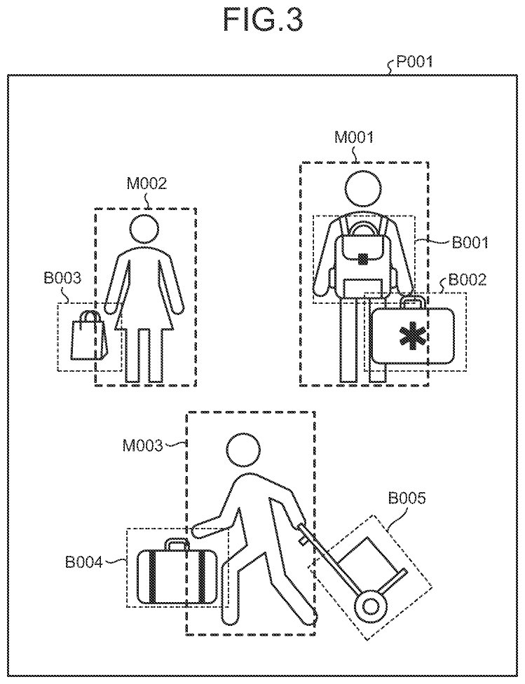

The categorization information to be generated by the categorization information generation unit 12 will next be described using an example in which the sensors provided in the on-demand vehicle 2 and in the roadside unit 3 are each an imaging apparatus, and the detection data includes an image. FIG. 3 is a diagram illustrating a first example of the detection data received by the communication unit 11 illustrated in FIG. 2. When the communication unit 11 outputs an image P001, the categorization information generation unit 12 recognizes the users and the objects included in this image P001. The categorization information generation unit 12 is capable of recognizing the users and the objects included in the image P001 in distinction from one another. The image P001 illustrated in FIG. 3 includes users M001 to M003 and objects B001 to B005. The categorization information generation unit 12 associates each of the objects B001 to B005 with an appropriate one of the users M001 to M003 as a possession of the appropriate one of the users M001 to M003 recognized, based on positional relationships between each of the objects B001 to B005 and each of the users M001 to M003. The categorization information generation unit 12 thus generates categorization information providing correspondence relationships between each of the users M001 to M003 and each of the objects B001 to B005. For example, the categorization information generation unit 12 can determine that an object located at a distance less than or equal to a threshold from a user is a possession of that user. In addition, the categorization information generation unit 12 may determine the owner of an object based on a temporal change in the location of the object relative to the user recognized. For example, when an object remains located at a distance less than or equal to a threshold from a user, the categorization information generation unit 12 can determine that this object is a possession of that user. Use of a temporal change can improve the degree of accuracy of the categorization information. When an object located in a vicinity of a recognized user remains located in a vicinity of that user, the categorization information generation unit 12 can determine that the user is the owner of the object also using an image captured before the image P001 of concern was captured.

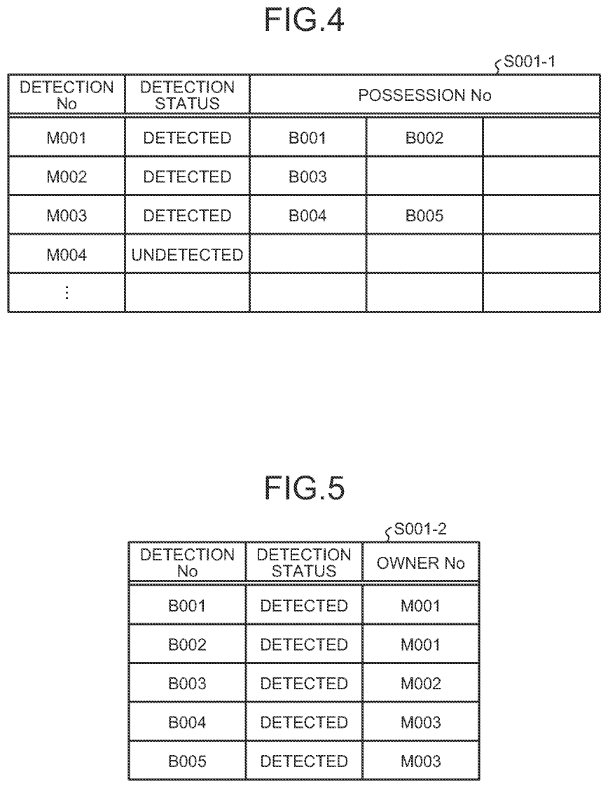

FIG. 4 is a diagram illustrating categorization information S001-1 generated based on the detection data illustrated in FIG. 3. The categorization information S001-1 provides correspondence relationships between the users and the possessions thereof on the basis of the users. The categorization information S001-1 includes a detection number, which is a user identifier for identifying each of the recognized users; a detection status of the user shown in the detection number column; and a possession number, which is an object identifier for identifying an object associated with the user shown in the detection number column as a possession of that user. No, one, or multiple object identifiers can be associated with one user identifier. As to the user M001, the object B001 and the object B002 are associated therewith as the possessions thereof. As to the user M002, the object B003 is associated therewith as the possession thereof. As to the user M003, the object B004 and the object B005 are associated therewith as the possessions thereof. Note that the categorization information generation unit 12 is described herein as generating a single set of the categorization information S001-1 from a single image P001. However, when the communication unit 11 obtains multiple images of a same time point, the categorization information generation unit 12 may generate a single set of categorization information based on the multiple images captured at the same time point. Generation of a single set of categorization information based on multiple images can improve accuracy of recognition of users and objects as compared to when a set of categorization information is generated based on a single image.

FIG. 5 is a diagram illustrating categorization information S001-2 generated based on the detection data illustrated in FIG. 3. The categorization information S001-2 provides correspondence relationships between the users and the possessions thereof on the basis of the objects. The categorization information S001-2 includes a detection number, which is an object identifier for identifying each of the recognized objects; a detection status of the object shown in the detection number column; and an owner number, which is a user identifier for identifying the user associated with the object shown in the detection number column as the owner of that object. No or one user identifier can be associated with one object identifier. The object B001 is associated with the user M001 as the owner thereof. The object B002 is associated with the user M001. The object B003 is associated with the user M002. The object B004 is associated with the user M003. The object B005 is associated with the user M003. The correspondence relationships provided by the categorization information S001-2 are the same as the correspondence relationships provided by the categorization information S001-1, and these sets of correspondence relationships differ from each other merely in the representation format thereof. Thus, either representation format may be used.

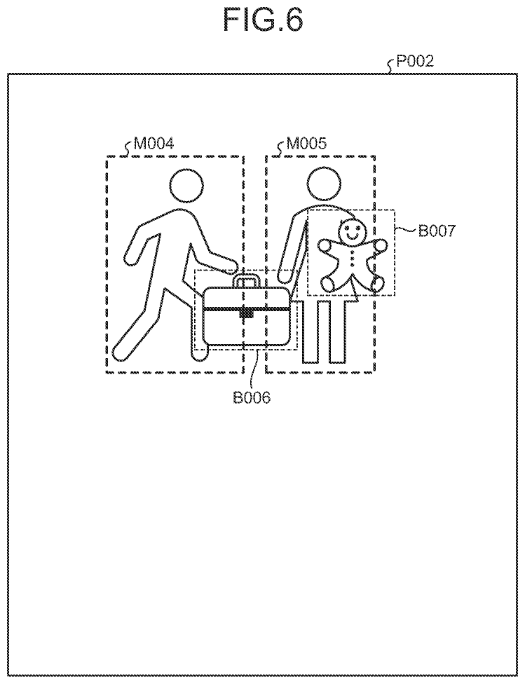

FIG. 6 is a diagram illustrating a second example of the detection data received by the communication unit 11 illustrated in FIG. 2. When the communication unit 11 outputs an image P002, the categorization information generation unit 12 recognizes the users and the objects included in the image P002. The image P002 shows users M004 and M005 and objects B006 and B007 recognized by the categorization information generation unit 12. As illustrated in the image P002, when the object B006 recognized is located in a vicinity of both the user M004 and the user M005, the categorization information generation unit 12 may be unable to identify the owner of the object B006.

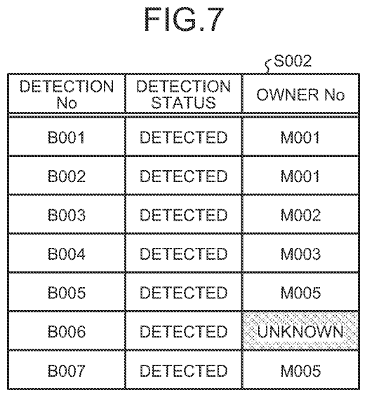

FIG. 7 is a diagram illustrating categorization information S002 generated based on the detection data illustrated in FIG. 6. When there are multiple candidates for the owner of the object B006 recognized by the categorization information generation unit 12 based on the image P002, the categorization information generation unit 12 generates the categorization information S002 representing failure in identifying the owner of the object B006. For example, as illustrated in FIG. 7, the categorization information generation unit 12 can determine that the owner number corresponding to the object B006 in the categorization information S002 is “unknown”. When the categorization information generation unit 12 has failed to identify the owner as described above, the categorization information generation unit 12 can identify the owner of the object B006 from multiple candidates using another image P003 obtained after obtainment of the image P002 that has been used for recognition. In this operation, when there are multiple candidates for the owner, and the owner of a recognized object cannot be identified, the categorization information generation unit 12 may instruct the devices including sensors (in this example, the on-demand vehicle 2 and the roadside unit 3) to increase the frequency of obtaining detection data depending on the frequency of obtaining detection data.

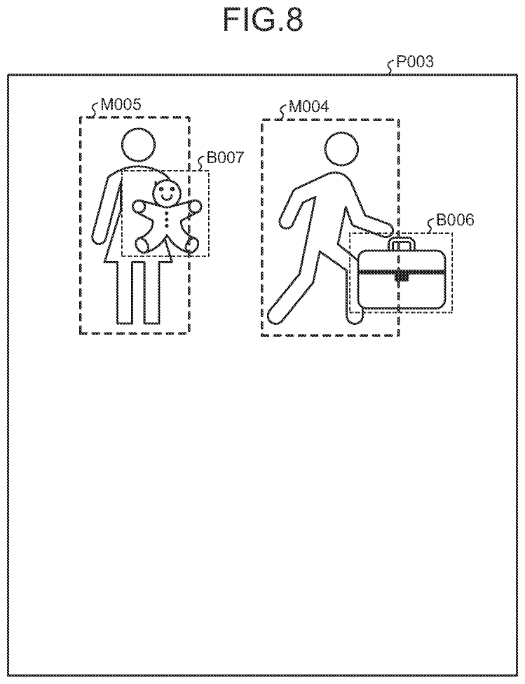

FIG. 8 is a diagram illustrating an example of detection data obtained after the detection data illustrated in FIG. 6 is obtained. The categorization information generation unit 12 is capable of recognizing, similarly to the case of the image P002, the users M004 and M005 and the objects B006 and B007 based on the image P003. In the image P003, the object B006 is apart from the user M005, and is located in a vicinity of the user M004. In this situation, the categorization information generation unit 12 can identity the user M004 as the owner of the object B006.

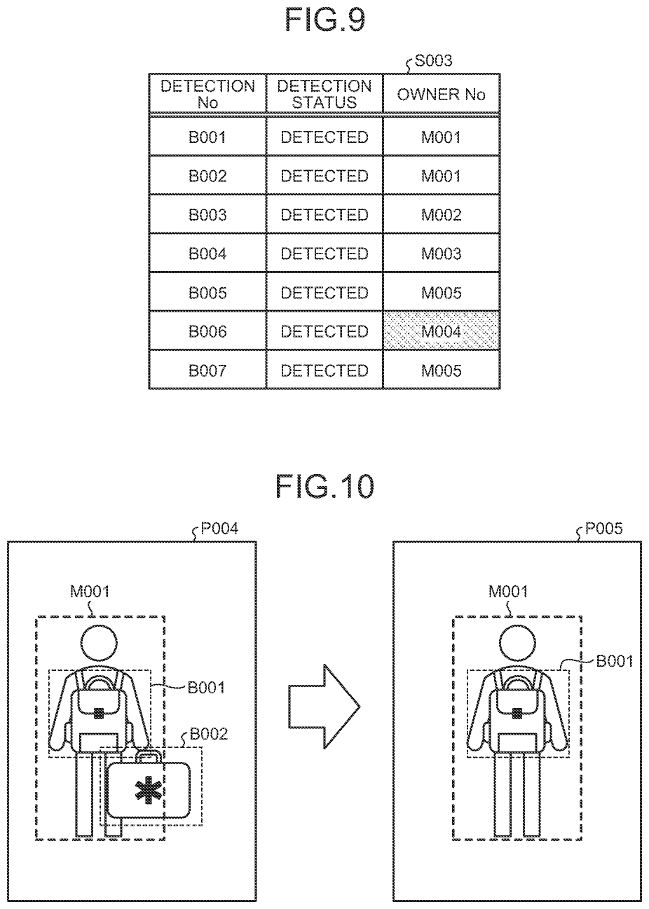

FIG. 9 is a diagram illustrating categorization information S003 generated based on the detection data illustrated in FIG. 8. In the categorization information S003, the user M004 is associated with the object B006 as the owner of the object B006.

Returning to the description with reference to FIG. 2, the categorization information comparison unit 13 compares, on a per-user basis, sets of categorization information as of multiple time points generated by the categorization information generation unit 12 to thereby determine whether a change has occurred in the situation of the possessions of the user. The categorization information comparison unit 13 compares at least categorization information as of before the user gets on the on-demand vehicle 2 and categorization information as of when the user gets off the on-demand vehicle 2. Note that “categorization information as of before the user gets on the on-demand vehicle 2” is categorization information generated based on detection data as of when the possessions that the user has taken into the on-demand vehicle 2 are detectable, and is, for example, categorization information generated based on detection data as of when the user is waiting for arrival of the on-demand vehicle 2 at one of the boarding-alighting spots. The categorization information comparison unit 13 may also determine whether a change has occurred in the situation of the possessions of the user, further using categorization information as of when the user is on board the on-demand vehicle 2. The categorization information comparison unit 13 outputs, to the warning notification unit 14, the result of the determination of whether a change has occurred in the situation of the possessions of the user.

FIG. 10 is a diagram illustrating an example of change in the detection data received by the communication unit 11 illustrated in FIG. 2. Assume, for example, that the communication unit 11 has received an image P004 as of before the user gets on the on-demand vehicle 2 and an image P005 as of when the user gets off the on-demand vehicle 2. The image P004 includes the user M001 and the objects B001 and B002 located in a vicinity of the user M001. The image P005 includes the user M001 and the object B001 located in a vicinity of the user M001, but does not include the object B002.

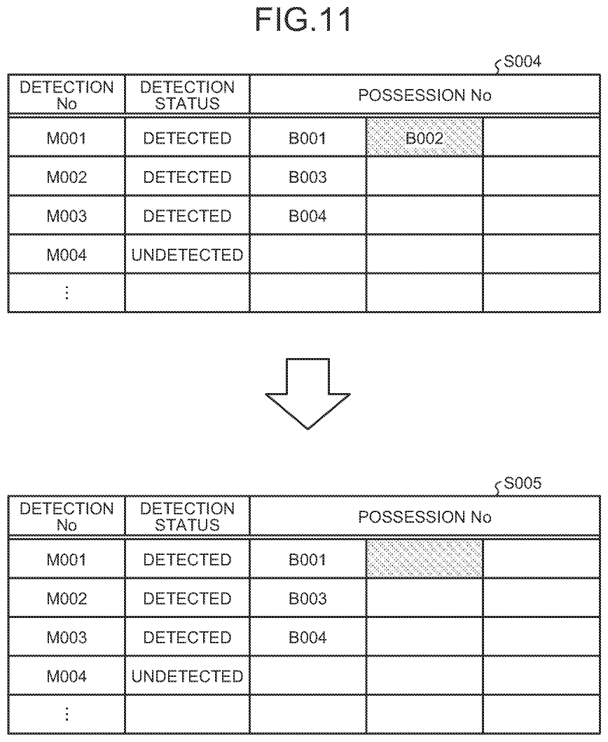

FIG. 11 is a diagram illustrating categorization information S004 and S005 generated from the detection data illustrated in FIG. 10. The categorization information generation unit 12 generates the categorization information S004 based on the image P004, and generates the categorization information S005 based on the image P005. The categorization information S004 associates the objects B001 and B002 with the user M001 as the possessions of the user M001, the object B003 with the user M002 as the possession of the user M002, and the object B004 with the user M003 as the possession of the user M003. In contrast, the categorization information S005 associates the object B001 with the user M001 as the possession of the user M001, the object B003 with the user M002 as the possession of the user M002, and the object B004 with the user M003 as the possession of the user M003. The categorization information comparison unit 13 compares the categorization information S004 and the categorization information S005, and can thus determine that a change has occurred in the situation of the possessions of the user M001, specifically, the number of possessions has decreased. In this case, the categorization information comparison unit 13 outputs, to the warning notification unit 14, a determination result indicating that the number of possessions of the user M001 has decreased. Note that the example illustrated in FIG. 11 includes a user who has undergone a decrease in the number of possessions, and includes no user who has undergone an increase in the number of possessions. However, when there is a user who has undergone an increase in the number of possessions, the categorization information comparison unit 13 also outputs, to the warning notification unit 14, a determination result including information of the user who has undergone an increase in the number of possessions.

Returning to the description with reference to FIG. 2, the warning notification unit 14 is capable of generating warning information based on the determination result output by the categorization information comparison unit 13, and of outputting the warning information generated, to each of the on-demand vehicle 2, the roadside unit 3, and the user terminal 4. Specifically, the warning notification unit 14 outputs warning information when the categorization information comparison unit 13 has determined that a change has occurred in the situation of the possessions of the user. Although the warning notification unit 14 has been described herein as outputting the warning information to all of the on-demand vehicle 2, the roadside unit 3, and the user terminal 4, the warning notification unit 14 outputs the warning information to at least one of the on-demand vehicle 2, the roadside unit 3, and the user terminal 4. The warning notification unit 14 is capable of identifying the user terminal 4 owned by the user who has undergone a change in the situation of the possessions, based on, for example, use reservation information corresponding to the on-demand vehicle 2, and of outputting the warning information to the user terminal 4 identified. For example, the use reservation information includes terminal information of the user, registered when the user reserved the use of the on-demand vehicle 2. Examples of the terminal information include a mobile-phone number, a mail address, and an account of social network service. In addition, in a case of a membership-based transport service, user information registered upon membership registration includes terminal information, and the on-demand vehicle management device 1 can identify, by using this terminal information, the user terminal 4 owned by the user who has undergone a change in the situation of the possessions.

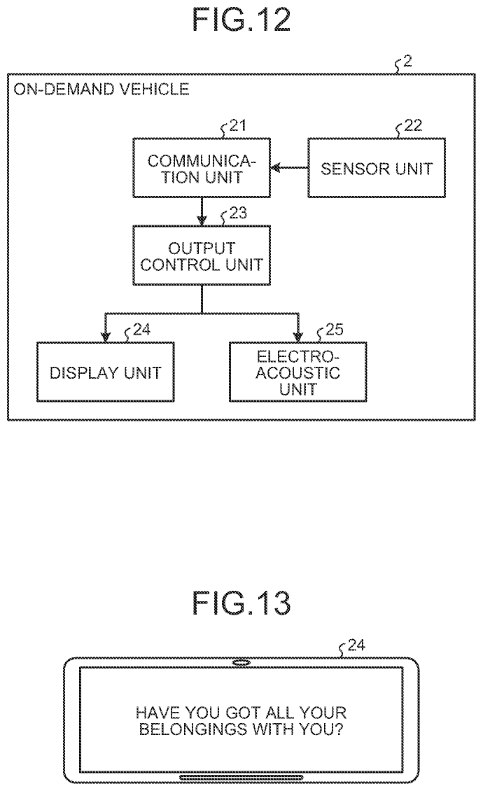

FIG. 12 is a diagram illustrating a functional configuration of the on-demand vehicle 2 illustrated in FIG. 1. The on-demand vehicle 2 includes a communication unit 21, a sensor unit 22, an output control unit 23, a display unit 24, and an electroacoustic unit 25.

The communication unit 21 communicates with other devices such as the on-demand vehicle management device 1, the roadside unit 3, and the user terminal 4 using a wireless communication scheme such as 4G, 5G, or Wi-Fi. Specifically, the communication unit 21 sends detection data output by the sensor unit 22 to the on-demand vehicle management device 1. In addition, the communication unit 21 receives warning information from the on-demand vehicle management device 1, and outputs the warning information received, to the output control unit 23.

The sensor unit 22 includes a sensor capable of detecting a user and an object in the on-demand vehicle 2, and outputs detection data output by the sensor, to the communication unit 21. Although the sensor included in the sensor unit 22 has been described herein as an imaging apparatus, the sensor may be a sonar, which detects an object using a sound wave; a radar, which detects an object using a radio wave; a light detection and ranging (LIDER), which detects an object using a laser; or the like. Such sensor may have functionality to obtain location information of a global positioning system (GPS) receiver provided on a detection target. When a GPS function is used, the sensor unit 22 can output detection data indicating that the detection target is located in the on-demand vehicle 2 when the distance between the location of the detection target and the location of the on-demand vehicle 2 is less than or equal to a threshold. In addition, although the sensor unit 22 has been described herein as including an in-vehicle sensor that outputs detection data obtained by sensing an interior of the on-demand vehicle 2, the sensor unit 22 may include a vehicle exterior sensor that is fitted on the body of the on-demand vehicle 2, and outputs detection data obtained by sensing an exterior of the on-demand vehicle 2 around the on-demand vehicle 2. Note that the term “interior” in the context of sensing performed by the in-vehicle sensor refers to an inside of the on-demand vehicle 2, more specifically, a space where the user can stay on board and a space where an object that is user's belongings can be loaded; and thus refers to the interior of the passenger room and the interior of the trunk, of the on-demand vehicle 2.

When the sensor unit 22 includes multiple sensors, adjustment of the position and orientation of each of the sensors allows a reduction of dead area, and can thus improve accuracy of lost item detection. Each of the sensors is desirably provided at a location where the user and the object inside the passenger room of the on-demand vehicle 2 are detectable with a less dead area, for example, a location such as near the interior mirror, near each seat, and/or near the ceiling at a boarding-alighting door. The sensor may also be provided in a trunk where user's belongings can be loaded. The sensor unit 22 may include multiple types of sensors.

The output control unit 23 outputs warning content from the on-demand vehicle management device 1, included in the warning information output by the communication unit 21, using at least one of the display unit 24 and the electroacoustic unit 25. The output control unit 23 is capable of displaying the warning information on a display screen of the display unit 24. The output control unit 23 is capable of causing the electroacoustic unit 25 to output a sound representing the warning information.

The display unit 24 includes a display device, and is capable of displaying information on the display screen thereof under the control of the output control unit 23. FIG. 13 is a diagram illustrating an example of the warning information displayed by the display unit 24 illustrated in FIG. 12. As illustrated in FIG. 13, the display unit 24 can output the warning information by displaying a message “Have you got all your belongings with you?” to advice the user to check whether the user has taken all the belongings. The display device of the display unit 24 may be installed in the passenger room of the on-demand vehicle 2 or outside the on-demand vehicle 2, and is desirably installed at a location where the display device is easily visible by the user of the on-demand vehicle 2.

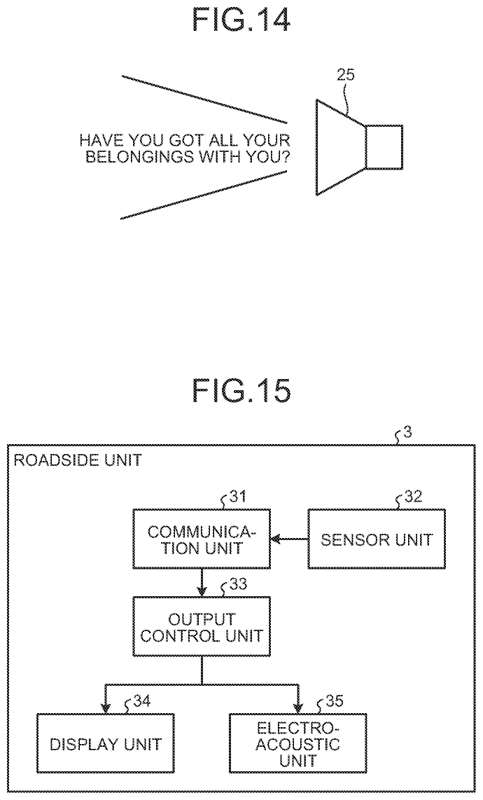

The electroacoustic unit 25 includes a speaker that outputs a sound, and is capable of outputting information from the speaker under the control of the output control unit 23. FIG. 14 is a diagram illustrating an example of the warning information output by the electroacoustic unit 25 illustrated in FIG. 12. As illustrated in FIG. 14, the electroacoustic unit 25 can output the warning information by outputting a message “Have you got all your belongings with you?” with sound. The electroacoustic unit 25 may alternatively output an audible alarm. Outputting of warning information with sound can increase the probability that the user will notice the warning information as compared to when the warning information is output only on the display screen.

In addition, the content of the warning information to be output to the user may be changed depending on the degree of accuracy of determination that a change has occurred in the situation of the possessions of the user. For example, the output message can be a predicative message depending on the degree of accuracy. The operation may be such that a message “Have you got all your belongings with you?” is output as the warning information when the degree of accuracy is low, while a message “You have left your belongings behind.” is output as the warning information when the degree of accuracy is high. Note that the degree of accuracy of determination that a change has occurred in the situation of the possessions of the user becomes higher with an increase in the degree of accuracy of determination about the situation of the possessions of the user. For example, the degree of accuracy of determination about the situation of the possessions of the user can be increased with an increase in the duration time in which the object is detected in a vicinity of the user. In addition, the degree of accuracy of determination about the situation of the possessions of the user can be high when the detection data used for a determination that the object is a possession of the user shows no other user who may be a candidate for the owner. The degree of accuracy of determination that a change has occurred in the situation of the possessions of the user can also be increased with an increase in the degree of accuracy of determination that the number of possessions “has increased or decreased”. For example, the degree of accuracy of determination that the number of possessions of the user “has decreased” can be increased as the distance between the user who is the owner and the object that is belongings of the user increases after determination that the user is the owner.

FIG. 15 is a diagram illustrating a functional configuration of the roadside unit 3 illustrated in FIG. 1. The roadside unit 3 includes a communication unit 31, a sensor unit 32, an output control unit 33, a display unit 34, and an electroacoustic unit 35.

The communication unit 31 communicates with other devices such as the on-demand vehicle management device 1, the on-demand vehicle 2, and the user terminal 4 using a wireless communication scheme such as 4G, 5G, or Wi-Fi. Specifically, the communication unit 31 sends detection data output by the sensor unit 32 to the on-demand vehicle management device 1. In addition, the communication unit 31 receives warning information from the on-demand vehicle management device 1, and outputs the warning information received, to the output control unit 33.

The sensor unit 32 includes a sensor for performing sensing around the on-demand vehicle 2 to detect the user getting on and off the on-demand vehicle 2 and the object that is belongings owned by the user. The sensor unit 32 outputs detection data output by the sensor to the communication unit 31. Although the sensor included in the sensor unit 32 has been described herein as an imaging apparatus, the sensor may be a sensor that uses a sonar, a radar, a LIDER, a GPS device, or the like similarly to the sensor included in the sensor unit 22. The sensor unit 32 may include multiple sensors and include multiple types of sensors. In addition, the sensor included in the sensor unit 32 is desirably installed at a location where the entire area around the boarding-alighting spot of the on-demand vehicle 2 is viewable with a less dead area, for example, a location such as on the roof of the boarding-alighting spot or on a guide board at the boarding-alighting spot.

The output control unit 33 outputs warning content from the on-demand vehicle management device 1, included in the warning information output by the communication unit 31, using at least one of the display unit 34 and the electroacoustic unit 35. The output control unit 33 is capable of displaying the warning information on a display screen of the display unit 34. The output control unit 33 is capable of causing the electroacoustic unit 35 to output a sound representing the warning information.

The display unit 34 includes a display device, and is capable of displaying information on the display screen thereof under the control of the output control unit 33. The display unit 34 is capable of, for example, displaying a message advising the user to check whether the user has not left the belongings behind, based on the warning information.

The electroacoustic unit 35 includes a speaker that outputs a sound, and is capable of outputting information from the speaker under the control of the output control unit 33. The electroacoustic unit 35 is capable of, for example, outputting a message advising the user to check whether the user has not left the belongings behind, based on the warning information. The electroacoustic unit 35 may alternatively output an audible alarm to attract attention to the display screen output by the display unit 34.

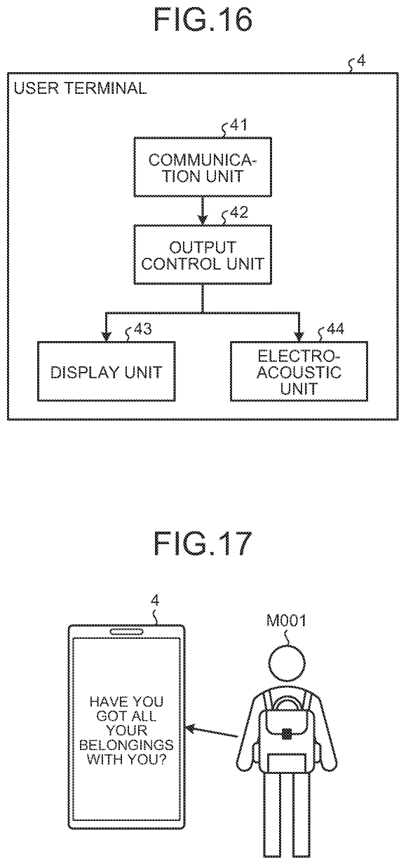

FIG. 16 is a diagram illustrating a functional configuration of the user terminal 4 illustrated in FIG. 1. The user terminal 4 is a mobile terminal owned by the user of the transport service using the on-demand vehicle 2. The user terminal 4 includes a communication unit 41, an output control unit 42, a display unit 43, and an electroacoustic unit 44.

The communication unit 41 communicates with other devices such as the on-demand vehicle management device 1, the on-demand vehicle 2, and the roadside unit 3 using a wireless communication scheme such as 4G, 5G, or Wi-Fi. Specifically, the communication unit 41 receives warning information from the on-demand vehicle management device 1, and outputs the warning information received, to the output control unit 42.

The output control unit 42 outputs warning content from the on-demand vehicle management device 1, included in the warning information output by the communication unit 41, using at least one of the display unit 43 and the electroacoustic unit 44. The output control unit 42 is capable of displaying the warning information on a display screen of the display unit 43. The output control unit 42 is capable of causing the electroacoustic unit 44 to output a sound representing the warning information.

The display unit 43 includes a display device, and is capable of displaying information on the display screen thereof under the control of the output control unit 42. The display unit 43 is capable of, for example, displaying a message advising the user to check whether the user has not left the belongings behind, based on the warning information. The display unit 43 is capable of, for example, displaying a message based on the warning information, on a screen of a dedicated software application having functionality to reserve use of a transport service using the on-demand vehicle 2. In this case, the user can be notified, in real time, of reception of the message using a notification feature of the application.

The electroacoustic unit 44 includes a speaker that outputs a sound, and is capable of outputting information from the speaker under the control of the output control unit 42. The electroacoustic unit 44 is capable of, for example, notifying the user that the user may have left a possession thereof, based on the warning information, by outputting a message advising the user to check whether the user has not left the belongings behind. The electroacoustic unit 44 may alternatively output an audible alarm to attract attention to the display screen output by the display unit 43.

FIG. 17 is a diagram illustrating an example of the warning information displayed by the user terminal 4 illustrated in FIG. 16. As illustrated in FIG. 17, the display unit 43 of the user terminal 4 is capable of displaying a message “Have you got all your belongings with you?” on the screen thereof. In this respect, the user M001, who is the owner of the user terminal 4 on which the warning information is displayed, is a user who has been determined by the on-demand vehicle management device 1 to have undergone a decrease in the number of possessions thereof. Note that when there is a user who has been determined by the on-demand vehicle management device 1 to have undergone an increase in the number of possessions thereof, a message indicating a possibility of occurrence of theft may be displayed on the user terminal 4 of the user M001. When the warning information includes information indicating that there is a user who has undergone an increase in the number of possessions, the output control unit 42 can output a message having a content different from the content of the message to be output when no user has been detected who has undergone an increase in the number of possessions, and only a user has been detected who has undergone a decrease in the number of possessions. Note that when a user has been detected who has undergone an increase in the number of possessions, the on-demand vehicle management device 1 desirably records and stores information relating to usage of the on-demand vehicle 2 of the user who has undergone an increase in the number of possessions. For example, the information to be stored includes information such as detection data including user information, the boarding time, the alighting time, the boarding location, and the alighting location, of the user who has been determined to have undergone an increase in the number of possessions thereof; a video including that user; and the like. When an investigation is to be made later into that case as a theft, the stored information can be used as investigation materials for characterization of the person of concern, and for verification of the situation at the time of the theft.

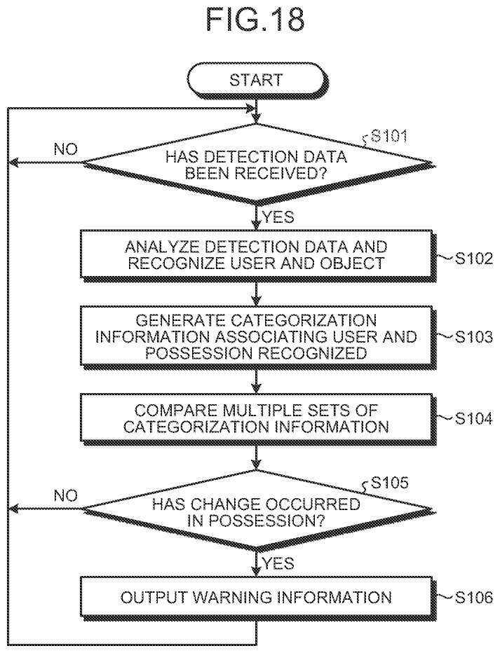

An operation of each device of the on-demand vehicle management system 100 will next be described. FIG. 18 is a flowchart for describing an operation of the on-demand vehicle management device 1 illustrated in FIG. 1.

The communication unit 11 determines whether detection data has been received from the on-demand vehicle 2 or the roadside unit 3 (step S101). When no detection data has been received (step S101: No), the communication unit 11 returns the process to step S101. When detection data has been received (step S101: Yes), the communication unit 11 outputs the detection data received, to the categorization information generation unit 12. The categorization information generation unit 12 analyzes the detection data, and recognizes the users of the on-demand vehicle 2 and the objects (step S102). The categorization information generation unit 12 generates categorization information that associates each of the users recognized with the possession of that user (step S103). The categorization information generation unit 12 outputs the categorization information generated, to the categorization information comparison unit 13.

The categorization information comparison unit 13 compares multiple sets of categorization information (step S104). In this operation, the categorization information comparison unit 13 makes a comparison, on a per-user basis, between multiple sets of categorization information including categorization information as of before the user gets on the on-demand vehicle 2 and categorization information as of when the user gets off the on-demand vehicle 2. The categorization information comparison unit 13 determines whether a change has occurred in the situation of the possessions of the user based on the result of the comparison between the multiple sets of categorization information, and outputs a determination result to the warning notification unit 14 (step S105).

When a change has occurred in the situation of the possessions (step S105: Yes), the warning notification unit 14 outputs warning information to each of the on-demand vehicle 2, the roadside unit 3, and the user terminal 4 (step S106). When no change has occurred in the situation of the possessions (step S105: No), the on-demand vehicle management device 1 returns the process to step S101.

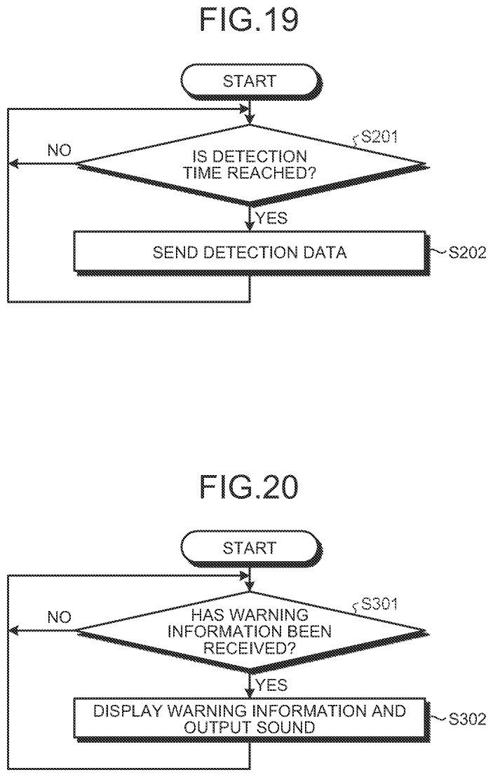

FIG. 19 is a flowchart for describing an operation of sending detection data performed by each of the on-demand vehicle 2 and the roadside unit 3 illustrated in FIG. 1. An operation of the on-demand vehicle 2 will herein be described, but a similar operation applies to the roadside unit 3.

The on-demand vehicle 2 determines whether a detection time is reached (step S201). For example, in a case in which the on-demand vehicle 2 sends detection data at predetermined intervals to the on-demand vehicle management device 1, the on-demand vehicle 2 can determine whether the detection time is reached based on the elapsed time since the detection data was previously sent.

When the detection time is reached (step S201: Yes), the on-demand vehicle 2 sends the detection data output by the sensor included in the sensor unit 22 to the on-demand vehicle management device 1 (step S202). When the detection time is not reached (step S201: No), or after the on-demand vehicle 2 sends the detection data at step S202, the on-demand vehicle 2 repeats the determination operation of step S201.

Note that the detection time may be, for example, each of the times when the user gets on and off the on-demand vehicle 2. In this case, the on-demand vehicle 2 can detect the times when the user gets on and off by, for example, detection of opening and closing of a door of the on-demand vehicle 2 and/or the weight on the on-demand vehicle 2. The roadside unit 3 installed at a boarding-alighting spot may define the detection time as a time when the on-demand vehicle 2 is stopping at the boarding-alighting spot.

FIG. 20 is a flowchart for describing an operation of outputting warning information performed by each of the on-demand vehicle 2, the roadside unit 3, and the user terminal 4 illustrated in FIG. 1. An operation of the on-demand vehicle 2 will herein be described, but a similar operation applies to the roadside unit 3 and to the user terminal 4. Note that the on-demand vehicle 2 and the roadside unit 3 may perform the operation illustrated in FIG. 20 in parallel with the operation illustrated in FIG. 19.

The on-demand vehicle 2 determines whether the on-demand vehicle 2 has received warning information from the on-demand vehicle management device 1 (step S301). When the warning information has been received (step S301: Yes), the on-demand vehicle 2 displays the warning information using the display unit 24, and outputs a sound such as message voice or an audible alarm based on the warning information using the electroacoustic unit 25 (step S302). When no warning information has been received (step S301: No), or after the on-demand vehicle 2 performs the operation of step S302, the on-demand vehicle 2 repeats the determination operation of step S301.

The foregoing operation of each of the devices included in the on-demand vehicle management system 100 allows the sensor provided in the roadside unit 3 installed at a boarding-alighting spot to perform sensing around a user during a time in which this user is waiting for arrival of the on-demand vehicle 2, and at a time when this user gets on the on-demand vehicle 2, at the boarding-alighting spot of the on-demand vehicle 2, thereby allowing such sensor to obtain detection data including data of this user and of the possession(s) of this user. Then, after the user gets on the on-demand vehicle 2, the sensor provided in the on-demand vehicle 2 periodically performs sensing of the vehicle interior to obtain detection data including data of the user and of the possession(s). In addition, when the user gets off the on-demand vehicle 2 at a boarding-alighting spot, the sensor provided in the roadside unit 3 at that boarding-alighting spot can perform sensing around this user, and can thus obtain detection data including data of the user and of the possession(s) of the user.

Furthermore, when the user gets off the on-demand vehicle 2, categorization information as of the time of getting off is compared with multiple sets of categorization information including at least categorization information as of when this user got on the on-demand vehicle 2 to determine whether no change has occurred in the situation of the possession(s). When a change has occurred in the situation of the possession(s) of the user because of leaving the belongings in the on-demand vehicle 2 by the user, of occurrence of theft, or of another similar cause, the on-demand vehicle management device 1 outputs warning information to the on-demand vehicle 2, to the roadside unit 3 installed near the place where the on-demand vehicle 2 is stopping, and to the user terminal 4 of the user who has undergone a change in the situation of the possession(s).

A hardware configuration of the on-demand vehicle management device 1 according to the first embodiment of the present disclosure will next be described. The on-demand vehicle management device 1 according to the first embodiment is implemented in, for example, a computer system. The on-demand vehicle management device 1 may be implemented in a single computer system or in a set of multiple computer systems. For example, the on-demand vehicle management device 1 may be implemented in a cloud system. A cloud system allows arbitrary setting of partitioning between the hardware of the computer system and a device such as a server for each functionality. For example, a single computer system may have functionality to serve as multiple devices, or multiple computer systems may have functionality to together serve as a single device.

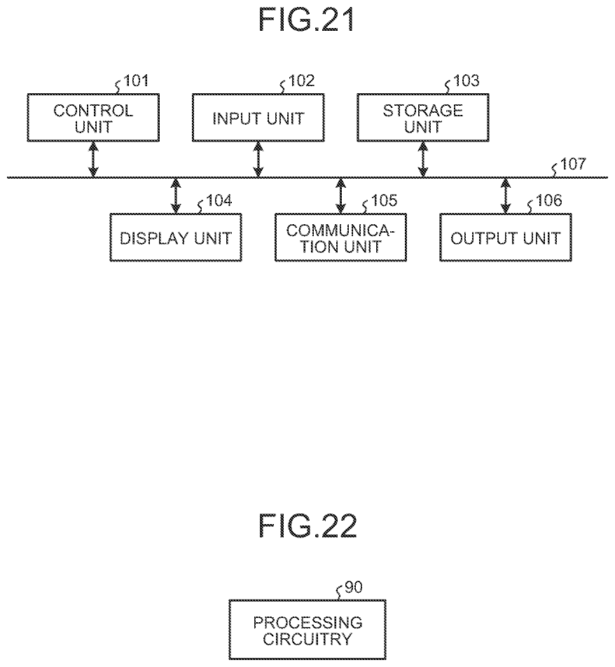

An example configuration of the computer system implementing the on-demand vehicle management device 1 will next be described. FIG. 21 is a diagram illustrating an example configuration of the computer system implementing the on-demand vehicle management device 1 according to the first embodiment. As illustrated in FIG. 21, this computer system includes a control unit 101, an input unit 102, a storage unit 103, a display unit 104, a communication unit 105, and an output unit 106, which are connected to one another via a system bus 107.

In FIG. 21, the control unit 101 is, for example, a central processing unit (CPU) or the like. The control unit 101 executes an on-demand vehicle management program, which describes the processing to be performed by the on-demand vehicle management device 1. The input unit 102 includes, for example, a keyboard, a mouse, and/or the like, and is used by the user of the computer system to input various types of information. The storage unit 103 includes some types of memories such as a random access memory (RAM) and/or a read-only memory (ROM), and a storage device such as a hard disk. The storage unit 103 stores the program to be executed by the above-mentioned control unit 101, necessary data obtained during a process, and the like. In addition, the storage unit 103 is also used as a temporary storage area for the program. The display unit 104 includes a liquid crystal display (LCD) panel and/or the like to display various screens for the user of the computer system. The communication unit 105 is a communication circuit for performing communication processing, or the like. The communication unit 105 may include multiple communication circuits respectively corresponding to multiple communication schemes. The output unit 106 is an output interface for outputting data to devices outside the computer system, such as a printer and an external storage device.

Note that the configuration illustrated in FIG. 21 is by way of example, and the configuration of the computer system is not limited to the example of FIG. 21. For example, the computer system may exclude the output unit 106. In addition, when the on-demand vehicle management device 1 is implemented by a set of multiple computer systems, all of these computer systems do not need to be the computer system illustrated in FIG. 21. For example, some of the computer systems may exclude at least one of the display unit 104, the output unit 106, and the input unit 102 illustrated in FIG. 21.

Description will now be given of an operation of the computer system to make ready for execution the on-demand vehicle management program that describes the processing to be performed by the on-demand vehicle management device 1 of the present embodiment. Regarding the computer system having the foregoing configuration, the on-demand vehicle management program is installed in the storage unit 103 from, for example, a compact disc (CD)-ROM or a digital versatile disc (DVD)-ROM placed in a CD-ROM drive or a DVD-ROM drive (each not illustrated). Then, for execution of the on-demand vehicle management program, the on-demand vehicle management program read from the storage unit 103 is loaded into an area serving as the main storage device of the storage unit 103. Under this condition, the control unit 101 performs processing to provide the functionality of the on-demand vehicle management device 1 of the present embodiment, according to the on-demand vehicle management program loaded to the storage unit 103.

Note that the foregoing description has been given of an example in which the program describing the processing to be performed by the on-demand vehicle management device 1 is provided using a CD-ROM or a DVD-ROM as a recording medium. However, the method for providing the program is not limited thereto. A program may be used that is provided, for example, using a transmission medium such as the Internet via the communication unit 105 depending on factors such as the configuration of the computer system and the size of the program to be provided. Note that the user terminal 4 can also be implemented using the computer system illustrated in FIG. 21.

A hardware configuration for implementing the functionality of the on-demand vehicle 2 and of the roadside unit 3 will next be described. Each of the functionality of the on-demand vehicle 2 and of the roadside unit 3 is implemented in a processing circuitry. These processing circuitries may each be implemented in a dedicated hardware element, or may each be a control circuit that uses a CPU.

When the forgoing processing circuitries are each implemented in a dedicated hardware element, these processing circuitries are each implemented in a processing circuitry 90 illustrated in FIG. 22. FIG. 22 is a diagram illustrating a dedicated hardware element for implementing the functionality of the on-demand vehicle 2 and of the roadside unit 3 according to the first embodiment. The processing circuitry 90 is a single circuit, a set of multiple circuits, a programmed processor, a parallel programmed processor, an application specific integrated circuit (ASIC), a field programmable gate array (FPGA), or a combination thereof.

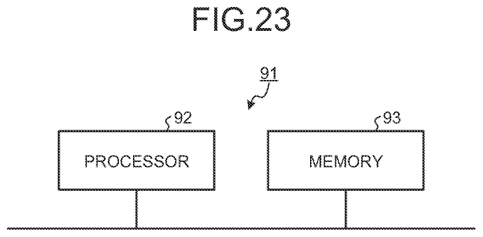

When the forgoing processing circuitries are each implemented in a control circuit that uses a CPU, this control circuit is, for example, a control circuit 91 having a configuration illustrated in FIG. 23. FIG. 23 is a diagram illustrating a configuration of the control circuit 91 for implementing the functionality of the on-demand vehicle 2 and of the roadside unit 3 according to the first embodiment. As illustrated in FIG. 23, the control circuit 91 includes a processor 92 and a memory 93. The processor 92 is a CPU, which is also known as a processing unit, a computing unit, a microprocessor, a microcomputer, a digital signal processor (DSP), or the like. The memory 93 is, for example, a non-volatile or volatile semiconductor memory such as a random access memory (RAM), a read-only memory (ROM), a flash memory, an erasable programmable ROM (EPROM), or an electrically erasable programmable ROM (EEPROM) (registered trademark); a magnetic disk, a flexible disk, an optical disk, a compact disc, a MiniDisc, a digital versatile disk (DVD), or the like.

When the forgoing processing circuitries are each implemented in the control circuit 91, the functionality is implemented in such a manner that the processor 92 reads and executes a program corresponding to the processing to be performed by the applicable component, stored in the memory 93. This program may be provided via a communication channel or in a form stored in a storage medium. The memory 93 is also used as a temporary memory for each processing performed by the processor 92.

As described above, according to the on-demand vehicle management device 1 according to the first embodiment, a user of the on-demand vehicle 2 is recognized, and categorization information is generated that associates each object represented by information included in detection data with a corresponding user of the on-demand vehicle 2 as a possession of that user, based on the detection data output by at least one of the sensor provided in or on the on-demand vehicle 2 and the sensor installed along the travel route of the on-demand vehicle 2. In addition, a comparison is made, on a per-user basis, between multiple sets of categorization information including categorization information as of before the user gets on the on-demand vehicle 2 and categorization information as of when the user gets off the on-demand vehicle 2 to thus determine whether a change has occurred in the situation of the possession(s) of the user. When it is determined that a change has occurred in the situation of the possession(s) of the user, warning information is output. The foregoing configuration allows warning information to be output based on a result of comparison between the situations of the possession(s) of each user as of before the user gets on the on-demand vehicle 2 and as of when the user gets off the on-demand vehicle 2. This allows improvement in accuracy of lost item detection. In particular, owing to lost item detection performed through a comparison between situations of the possession(s) on a per-user basis, belongings left behind of another user are not determined to be a lost item of the user of concern. In addition, in a service of a type in which multiple users simultaneously share a single on-demand vehicle 2, and get on and off at different places, belongings of a user remaining in the on-demand vehicle 2 after another user gets off will not be detected as a lost item as long as the user of the belongings has not got off. This improves accuracy of lost item detection.

In particular, a service using an autonomous-running on-demand vehicle 2 involves no driver, thereby making it difficult to check for a lost item each time a user gets on and off the on-demand vehicle 2. Accordingly, improvement in accuracy of lost item detection and enabling prompt notification of a lost item when a user gets off can reduce labor cost for lost item-related work. In addition, even when, for example, a user has taken a suspicious item into the on-demand vehicle 2, use of the foregoing technology allows belongings to be detected as a lost item when the user who has taken the belongings into the on-demand vehicle 2 moves away from the belongings. This enables a prompt response to a suspicious item or the like, which is also contributory to security enhancement. Moreover, a theft may be committed when multiple users simultaneously share a single on-demand vehicle 2. In a case of a theft, extraction of a user who has undergone an increase in the number of possessions can identify a user who may have committed the theft.

The configurations described in the foregoing embodiment are merely examples of various aspects of the present disclosure. These configurations may be combined with a known other technology, and moreover, part of such configurations may be omitted and/or modified without departing from the spirit of the present disclosure.

For example, the foregoing first embodiment has been described in which the on-demand vehicle 2 sends detection data that is periodically obtained by the sensor unit 22 to the on-demand vehicle management device 1, but when the accessory power source has been turned off indicating that there is obviously no passenger, there is no need to send the detection data.

In addition, the foregoing first embodiment has been described in which the detection data is periodically obtained, but it is sufficient that the detection data is obtained at least before the user gets on the on-demand vehicle 2 and when the user gets off the on-demand vehicle 2. When the detection data is obtained only when the user gets on and off the on-demand vehicle 2, and the owner of an object was failed to be identified from multiple candidates for the owner of the object recognized based on the detection data, the categorization information generation unit 12 may instruct the device including the sensor to increase the frequency of obtaining the detection data.

Moreover, the foregoing first embodiment has been described in which the categorization information generation unit 12 generates categorization information each time the detection data is periodically obtained, but the categorization information generation unit 12 does not necessarily need to generate the categorization information each time the detection data is obtained. When the frequency of obtaining the detection data is high, the frequency of generating the categorization information may be reduced to a frequency lower than the frequency of obtaining the detection data to generate a single set of categorization information based on multiple sets of detection data.

Furthermore, the foregoing first embodiment has been described in which the on-demand vehicle 2 stops at multiple predetermined boarding-alighting spots, but the on-demand vehicle 2 may stop, for example, at any location specified by the user on a map displayed by a software application. In this case, when one roadside unit 3 among the multiple roadside units 3 installed along the travel route is located near the stopping location of the on-demand vehicle 2, detection data obtained by sensing around the on-demand vehicle 2 can be obtained. Note that when the on-demand vehicle 2 is to stop at any location, installation of a vehicle exterior sensor on the on-demand vehicle 2 enables detection data obtained by sensing around the stopping on-demand vehicle 2 to be obtained without increasing the number of installations of the roadside units 3 no matter where the on-demand vehicle 2 stops.

Note that the foregoing first embodiment has been described in which the on-demand vehicle management system 100 includes the on-demand vehicle management device 1, the on-demand vehicle 2, and the roadside unit 3, but this configuration is by way of example. For example, the on-demand vehicle management system 100 may be configured to include the on-demand vehicle management device 1 and the roadside unit 3, and not to include the on-demand vehicle 2. In this case, the roadside unit 3 obtains the detection data at a location where the user gets on the on-demand vehicle 2 and at a location where the user gets off the on-demand vehicle 2, and the on-demand vehicle management device 1 associates a user and a possession in the on-demand vehicle 2 based on the detection data. The on-demand vehicle management device 1 then compares the situation of the possession(s) as of when the user gets on and the situation of the possession(s) as of when the user gets off. When a possession is left in the on-demand vehicle 2, the on-demand vehicle management device 1 outputs warning information to the roadside unit 3. Upon reception of the warning information, the roadside unit 3 notifies the appropriate person of the lost item using output means such as a speaker and/or a monitor. In addition, use of an in-vehicle sensor of the on-demand vehicle 2 as described in the foregoing first embodiment enables the situation of the possession(s) of the user as of when the user is about to get off, rather than after the user gets off, to be detected. In this case, the user can be notified of a lost item immediately before the user gets off the on-demand vehicle 2 using output means such as a speaker and/or a monitor installed on the on-demand vehicle 2, which may enable prevention of leaving the possessions in the on-demand vehicle 2. Moreover, when warning information can be output to the user terminal 4, the appropriate person can be notified of a lost item even after the user leaves the on-demand vehicle 2 and the boarding-alighting spot.

### REFERENCE SIGNS LIST

1 on-demand vehicle management device; 2 on-demand vehicle; 3 roadside unit; 4 user terminal; 5 communication channel; 11, 21, 31, 41, 105 communication unit; 12 categorization information generation unit; 13 categorization information comparison unit; 14 warning notification unit; 22, 32 sensor unit; 23, 33, 42 output control unit; 24, 34, 43, 104 display unit; 25, 35, 44 electroacoustic unit; 90 processing circuitry; 91 control circuit; 92 processor; 93 memory; 100 on-demand vehicle management system; 101 control unit; 102 input unit; 103 storage unit; 106 output unit; 107 system bus; P001 to P005 image; M001 to M005 user; B001 to B007 object; S001-1, S001-2, S002 to S005 categorization information.

1. An on-demand vehicle management device comprising:
a communication circuitry to receive detection data output by at least one of a sensor provided in or on an on-demand vehicle operated based on a use request from a user or a sensor installed along a travel route of the on-demand vehicle;
a categorization information generation circuitry to recognize a user who uses the on-demand vehicle, based on the detection data, and to generate categorization information that associates an object represented by information included in the detection data with the user, as a possession of the user;
a categorization information comparison circuitry to determine whether a change has occurred in a situation of the possession of the user by making a comparison, on a per-user basis, between a plurality of sets of the categorization information including the categorization information as of before the user gets on the on-demand vehicle and the categorization information as of when the user gets off the on-demand vehicle; and
a warning notification circuitry to output warning information when the categorization information comparison circuitry determines that a change has occurred in the situation of the possession of the user.

2. The on-demand vehicle management device according to claim 1, wherein the detection data received by the communication circuitry includes the detection data obtained by sensing an interior of the on-demand vehicle and the detection data obtained by sensing an exterior of the on-demand vehicle.

3. The on-demand vehicle management device according to claim 1, wherein the communication circuitry receives the detection data output by an in-vehicle sensor, and output by a vehicle exterior sensor or by a sensor provided in a roadside communicator installed along the travel route, the in-vehicle sensor being a sensor provided inside a passenger room of the on-demand vehicle, the vehicle exterior sensor being a sensor provided outside the passenger room.

4. The on-demand vehicle management device according to claim 3, wherein the communication circuitry receives the detection data from multiple ones of the in-vehicle sensor.

5. The on-demand vehicle management device according to claim 1, wherein the warning notification circuitry outputs the warning information to at least one of a user terminal owned by the user who has undergone a change in the situation of the possession, the on-demand vehicle, or a roadside communicator installed along the travel route.

6. The on-demand vehicle management device according to claim 1, wherein the warning notification circuitry identifies a user terminal owned by the user who has undergone a change in the situation of the possession based on use reservation information relating to the on-demand vehicle, and outputs the warning information to the user terminal.

7. The on-demand vehicle management device according to claim 1, wherein when a determination has been made that a change has occurred in the situation of the possession of the user, the warning notification circuitry changes a content of the warning information depending on a degree of accuracy of the determination.

8. The on-demand vehicle management device according to claim 1, wherein the categorization information comparison circuitry determines whether a change has occurred in the situation of the possession of the user further using categorization information as of when the user is on board the on-demand vehicle.

9. The on-demand vehicle management device according to claim 1, wherein the categorization information generation circuitry determines an owner of the object based on a temporal change in a location of the object relative to the user.

10. The on-demand vehicle management device according to claim 1, wherein when there are a plurality of candidates for an owner of the object recognized, the categorization information generation circuitry identifies the owner of the object from the plurality of candidates, using another set of the detection data obtained after obtainment of the detection data that has been used for recognition.

11. The on-demand vehicle management device according to claim 1, wherein when the possession of the user has decreased in number, the warning notification circuitry outputs the warning information indicating that the user may have left the possession in the on-demand vehicle.

12. The on-demand vehicle management device according to claim 1, wherein
the on-demand vehicle is shareable by a plurality of users for transportation, and
when there are a user whose possession has increased in number and a user whose possession has decreased in number, the warning notification circuitry outputs the warning information to a user terminal owned by the user whose possession has increased in number and to a user terminal owned by the user whose possession has decreased in number.

13. An on-demand vehicle management system comprising:
an on-demand vehicle management device communicable with an on-demand vehicle operated based on a use request from a user; and
a roadside communicator including a sensor capable of detecting the user of the on-demand vehicle, the roadside communicator being installed along a travel route of the on-demand vehicle, wherein
the on-demand vehicle management device includes
a communication circuitry to receive detection data output by the sensor,
a categorization information generation circuitry to recognize the user who uses the on-demand vehicle, based on the detection data, and to generate categorization information that associates an object represented by information included in the detection data with the user, as a possession of the user,
a categorization information comparison circuitry to determine whether a change has occurred in a situation of the possession of the user by making a comparison, on a per-user basis, between a plurality of sets of the categorization information including the categorization information as of before the user gets on the on-demand vehicle and the categorization information as of when the user gets off the on-demand vehicle, and
a warning notification circuitry to output warning information when the categorization information comparison circuitry determines that a change has occurred in the situation of the possession of the user.

14. A lost item detection method for use in an on-demand vehicle management device that manages an on-demand vehicle operated based on a use request from a user, the lost item detection method comprising:
receiving, by the on-demand vehicle management device, detection data output by at least one of a sensor provided in or on the on-demand vehicle or a sensor installed along a travel route of the on-demand vehicle;
recognizing, by the on-demand vehicle management device, the user of the on-demand vehicle based on the detection data;
generating, by the on-demand vehicle management device, categorization information that associates an object represented by information included in the detection data with the user, as a possession of the user;
determining, by the on-demand vehicle management device, whether a change has occurred in a situation of the possession of the user by making a comparison, on a per-user basis, between a plurality of sets of the categorization information including the categorization information as of before the user gets on the on-demand vehicle and the categorization information as of when the user gets off the on-demand vehicle; and
outputting by the on-demand vehicle management device, warning information when a determination has been made that a change has occurred in the situation of the possession of the user.

15. (canceled)
